(19) United States
(12) Patent Application Publication
(10) Pub. No.: US 2021/0131612 A1
(43) Pub. Date: May 6, 2021

(54) Method of Supplying LNG From A Supply Hub Using A Dual Purpose LNG Carrier And A Smaller-Volume Storage At A Receiving Terminal

(71) Applicant: ExxonMobil Upstream Research Company, Spring, TX (US)

(72) Inventors: Maciej LUKAWSKI, Spring, TX (US); Charles J. MART, Tomball, TX (US)

(21) Appl. No.: 17/063,000

(22) Filed: Oct. 5, 2020

Related U.S. Application Data
(60) Provisional application No. 62/927,750, filed on Oct. 30, 2019.

(51) Int. Cl. F17C 6/00; F17C 9/00; B67D 7/78; B67D 9/00

(52) U.S. Cl. CPC F17C 6/00; F17C 9/00; B67D 7/78; B67D 9/00; F17C 2225/0153; F17C 2205/0352; F17C 2221/033; F17C 2223/0161; F17C 2201/052

(57) ABSTRACT

A method for regasification of liquefied natural gas (LNG) and an LNG regasification terminal employing said method. An LNG carrier is filled with LNG at an LNG hub and transports the LNG to a receiving terminal. The LNG is offloaded to LNG storage at the receiving terminal. The LNG storage has less storage capacity than the storage capacity of the carrier. The LNG is regasified at a regasification rate at the receiving terminal. The carrier is maintained at the receiving terminal until the carrier is empty, and then returns to the LNG hub to be filled with more LNG. The process is then repeated. The storage capacity of the LNG storage is sufficient to supply LNG for regasifying the LNG at the regasification rate until the carrier returns with additional LNG from the LNG hub. The carrier is the sole source of LNG for the receiving terminal.

This application claims the priority benefit of U.S. Provisional Patent Application No. 62/927,750, filed Oct. 30, 2019, entitled METHOD OF SUPPLYING LNG FROM A SUPPLY HUB USING A DUAL PURPOSE LNG CARRIER AND A SMALLER-VOLUME STORAGE AT A RECEIVING TERMINAL.

### BACKGROUND

### Field of Disclosure

The disclosure relates generally to the field of natural gas liquefaction to form liquefied natural gas (LNG). More specifically, the disclosure relates to the transport of LNG from LNG supply/distribution hubs to LNG receiving/import terminals.

### Description of Related Art

This section is intended to introduce various aspects of the art, which may be associated with the present disclosure. This discussion is intended to provide a framework to facilitate a better understanding of particular aspects of the present disclosure. Accordingly, it should be understood that this section should be read in this light, and not necessarily as an admission of prior art.

LNG is a rapidly growing means to supply natural gas from locations with an abundant supply of natural gas to distant locations with a strong demand for natural gas. The conventional LNG production cycle includes: a) initial treatments of the natural gas resource to remove contaminants such as water, sulfur compounds and carbon dioxide; b) the separation of some heavier hydrocarbon gases, such as propane, butane, pentane, etc. by a variety of possible methods including self-refrigeration, external refrigeration, lean oil, etc.; c) refrigeration of the natural gas substantially by external refrigeration to form liquefied natural gas at or near atmospheric pressure and about −160° C.; d) transport of the LNG product in ships or tankers designed for this purpose to an import terminal associated with a market location; and e) re-pressurization and regasification of the LNG at a regasification plant to a pressurized natural gas that may distributed to natural gas consumers.

Most LNG import terminals have been located in markets with high demand, where economies of scale associated with increasingly large LNG carrier ships have resulted in cost reductions over time. Such import terminals have large processing capacities, typically 3 to 20+ million tons per year (MTA). Much of the future demand growth for LNG, however, is expected to come from new markets, which have much smaller processing capacities, e.g., 0.1 to 1 MTA. One strategy for delivering gas to coastal demand centers in these new markets is to transport it from an LNG hub (i.e., a larger import terminal or a natural gas liquefaction plant) to smaller, satellite receiving terminals using large LNG carriers. Each receiving terminal can have a form of onshore terminal or a nearshore or offshore vessel commonly referred to as a floating storage and regasification unit (FSRU). The FSRU option is depicted in the LNG receiving terminal 100 of FIG. 1, in which an FSRU was either built as a new ship, or an LNG carrier (LNGC) has been converted to an FSRU 102. An LNG carrier 104 transports LNG from an LNG hub (not shown). LNG carrier 104 transfers its LNG to the FSRU 102, where it is stored and regasified. The FSRU has LNG storage capacity comparable or exceeding that of an LNG carrier 104, which enables the LNG carrier to immediately unload its cargo into the FSRU and return to the LNG hub, only returning to refill the FSRU when needed. In this manner a single FSRU may service multiple such receiving terminals. Likewise, onshore terminals have LNG storage capacity comparable to or exceeding the LNGC. Both the onshore and FSRU processing approaches require capital-intensive regasification terminals with significant LNG storage volume and dedicated large LNGCs operating as shuttles between the hub and multiple receiving terminals. What is needed is an inexpensive method of supplying LNG to smaller LNG receiving terminals.

### SUMMARY

The present disclosure provides a method for regasification of liquefied natural gas (LNG). An LNG carrier is filled with LNG at an LNG hub and transports the LNG to an LNG receiving terminal. The LNG is offloaded to LNG storage at the LNG receiving terminal. The LNG storage has less storage capacity than the storage capacity of the LNG carrier. The LNG is regasified at a regasification rate using regasification equipment at the LNG receiving terminal. The LNG carrier is maintained at the LNG receiving terminal until the LNG carrier is empty. The LNG carrier returns to the LNG hub when the LNG carrier is empty and is filled with more LNG. The process is then repeated. The storage capacity of the LNG storage is sufficient to supply LNG to the regasification equipment to maintain regasifying the LNG at the regasification rate until the LNG carrier returns with additional LNG from the LNG hub. The LNG carrier is the sole source of LNG for the LNG receiving terminal.

The present disclosure also provides a liquefied natural gas (LNG) regasification terminal. An LNG carrier is filled with LNG at an LNG hub. The LNG carrier is directed to an LNG receiving terminal. The LNG carrier is the sole source of LNG for the LNG receiving terminal. The LNG receiving terminal includes an LNG storage having a capacity less than the storage capacity of the LNG carrier. The LNG carrier offloads the LNG to the LNG storage. The LNG receiving terminal also includes regasification equipment that regasifies the LNG stored in the LNG storage at a regasification rate. The LNG carrier is maintained at the LNG receiving terminal until the carrier is empty. The LNG carrier returns to the LNG hub when the LNG carrier is empty. The storage capacity of the LNG storage is sufficient to supply LNG to the regasification equipment to maintain regasifying the LNG at the regasification rate until the LNG carrier returns with additional LNG from the LNG hub.

The foregoing has broadly outlined the features of the present disclosure so that the detailed description that follows may be better understood. Additional features will also be described herein.

### BRIEF DESCRIPTION OF THE DRAWINGS

These and other features, aspects and advantages of the disclosure will become apparent from the following description, appending claims and the accompanying drawings, which are briefly described below.

FIG. 1 is a simplified diagram of a method of LNG regasification according to known principles.

FIG. 2 is a simplified diagram of a method of LNG regasification according to disclosed aspects.

FIG. 3 is a simplified diagram of a method of LNG regasification according to disclosed aspects.

FIG. 4 is a flowchart showing a method of LNG regasification according to disclosed aspects.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

To promote an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. For the sake clarity, some features not relevant to the present disclosure may not be shown in the drawings.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As one of ordinary skill would appreciate, different persons may refer to the same feature or component by different names. This document does not intend to distinguish between components or features that differ in name only. The figures are not necessarily to scale. Certain features and components herein may be shown exaggerated in scale or in schematic form and some details of conventional elements may not be shown in the interest of clarity and conciseness. When referring to the figures described herein, the same reference numerals may be referenced in multiple figures for the sake of simplicity. In the following description and in the claims, the terms “including” and “comprising” are used in an open-ended fashion, and thus, should be interpreted to mean “including, but not limited to.”

The articles “the,” “a” and “an” are not necessarily limited to mean only one, but rather are inclusive and open ended so as to include, optionally, multiple such elements.

As used herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

According to disclosed aspects, a new method of delivery and regasification of liquefied natural gas (LNG) is provided. The method uses a single ship operating as both a floating storage unit and an LNG carrier at different periods of time, and a floating or onshore regasification unit with a relatively small LNG storage volume. Most of the time, the LNG carrier is docked and operates as floating storage unit to store LNG. When the LNG stored in the LNG carrier is depleted, the ship travels to the hub to refill its LNG cargo, and LNG stored on the stationary regasification unit is used to provide a continuous LNG supply to the regasification unit. Upon return, the LNG carrier refills the LNG storage at the regasification unit and remains at the satellite location, operating as a floating storage unit, and the cycle is repeated.

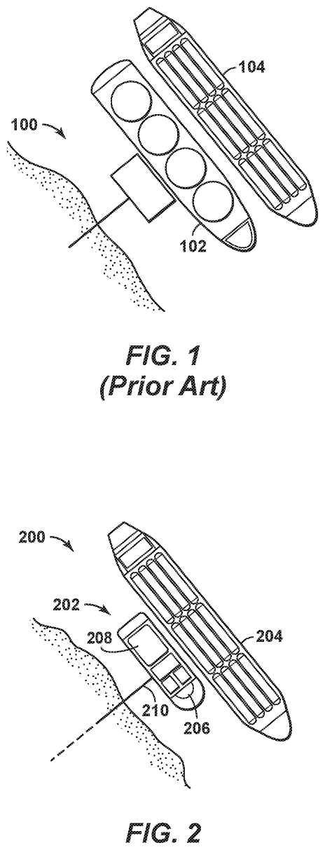

FIG. 2 depicts an LNG receiving terminal 200 according to disclosed aspects. LNG receiving terminal 200 includes a regasification unit 202 and an LNG carrier 204. Regasification unit 202 includes regasification equipment 206 and LNG storage 208. The LNG storage 204 is designed to have a storage capacity of about 20,000 cubic meters of LNG, or between about 5,000 and about 50,000 cubic meters, or between about 10,000 and about 35,000 cubic meters, or less than 40,000 cubic meters, or less than 30,000 cubic meters. Regasification unit 202 may be an onshore regasification unit, or may be a floating regasification unit that is tethered, moored, or otherwise secured offshore or nearshore. A floating regasification unit, shown in FIG. 2, will require a natural gas connector 210 to transfer natural gas regasified thereon to an onshore gas distribution network, power station, or other location where the natural gas is to be used. Known designs of floating regasification units may be used provided their storage capacities are within the scope specified above.

LNG carrier 204 may be a commercial LNG carrier that has been converted to function as a floating storage unit as well. In a preferred aspect, LNG carrier 204 may be an older type or classification of carrier, such as a Moss type LNG carrier. These older carriers typically have a smaller transport capacity and are less cost-efficient than modern LNG carriers, i.e., 120,000 to 140,000 cubic meters compared to 170,000 to 260,000 cubic meters.

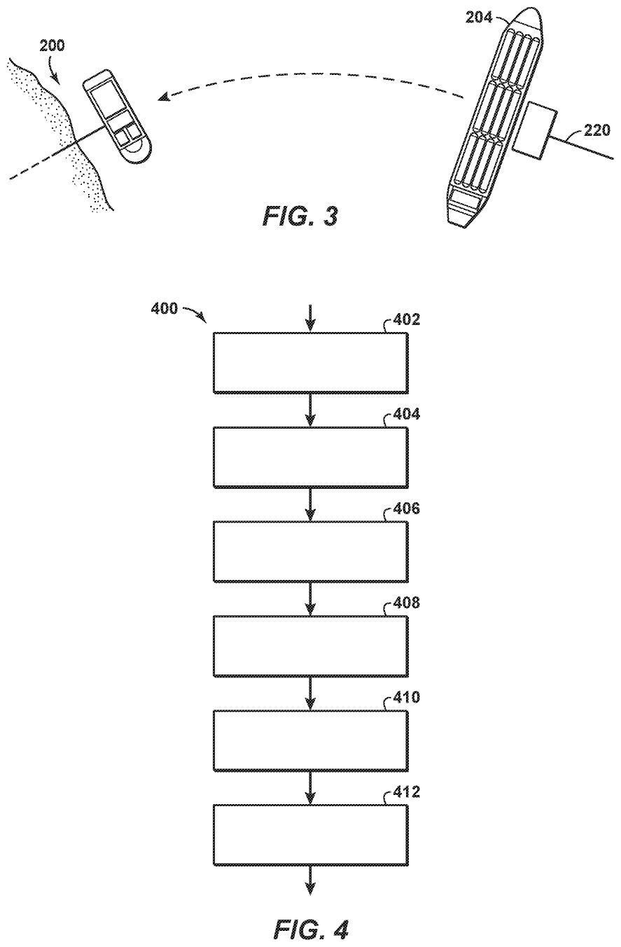

In operation, LNG carrier 204 is filled with LNG at an LNG hub 220 (FIG. 3), which may be less than 2,000 kilometers, or less than 2,500 kilometers, or less than 3,000 kilometers, or no greater than 3,500 kilometers, or no greater than 4,000 kilometers away from the LNG receiving terminal 200. LNG hub 220 may be an LNG liquefaction facility or an LNG transportation hub, which receives LNG from an LNG liquefaction facility. The LNG carrier travels to the LNG receiving terminal 200, where it is again docked adjacent regasification unit 202 (FIG. 2). LNG is transferred to the regasification unit 202. In an aspect, LNG is transferred to the LNG storage 208 and then regasified. In an alternative aspect, part of the LNG is transferred to the LNG storage while another part of the LNG is transferred directly to the regasification equipment 206. In any event, LNG carrier 204 remains docked adjacent regasification unit 202 until the LNG carrier is empty (or in the event of an emergency event, which usually is weather-related), at which time the LNG carrier returns to LNG hub 220 to obtain another load of LNG. For purposes of the disclosure, the LNG carrier is empty when substantially all LNG has been offloaded therefrom, it being understood that a very small amount (i.e., a “heel” of about 1-3% of the full cargo volume) of LNG may remain in the LNG tanks to maintain the temperature of the LNG tanks. At the time the LNG carrier leaves the LNG receiving terminal, the LNG storage 208 contains enough LNG to maintain a constant supply of LNG to the regasification equipment 206 until the LNG carrier returns to LNG receiving terminal 200 from LNG hub with another load of LNG.

According to another aspect of the disclosure, the LNG carrier 204 may be designed to service regasification units at multiple LNG receiving terminals. In this aspect, the LNG carrier remains docked at LNG receiving terminal 200 until enough LNG has been offloaded and stored onshore to ensure a sufficient LNG supply until the LNG carrier returns to the LNG receiving terminal 200. The LNG carrier may then un-dock with LNG stored thereon and deliver the remaining LNG to other regasification units. When empty (or substantially empty, as explained above), the LNG carrier returns to the LNG hub to be filled again with LNG. The LNG carrier then repeats its deliveries to the multiple receiving terminals.

The disclosed method has an advantage of requiring only one vessel per receiving terminal, which may result in lower capital and operating costs. Such ship may be an older-generation LNG carrier, which may no longer be cost competitive if used solely as a shuttle due to having less efficient engines and a smaller cargo capacity compared to newer generation ships. The low efficiency of this type of ship would have little impact on the economics of the proposed method, as the LNG carrier would remain stationary most of the time. Furthermore, a single LNG hub may service multiple regasification unit/LNG carrier pairs, thereby increasing the number of small markets able to be reached using the disclosed method.

It should be noted that practical applications of the disclosed method would likely be limited to receiving terminal locations 1) which have sufficient water depth to allow marine access of a dual purpose LNG carrier/floating storage vessel as disclosed herein or where the cost of dredging would not be prohibively high, and 2) sufficiently close to the LNG hub to prevent excessively large LNG storage volume of the stationary storage and regasification unit. For example, for a 300 MW electricity demand, a floating regasification unit having a storage capacity of 20,000 cubic meters and converted LNG carrier having a transport/storage capacity of 135,000 cubic meters may limit the distance between the LNG hub and the receiving terminal to about 3,000 kilometers. This distance limitation assumes electricity production at 45% efficiency, one day at the LNG hub required to load the LNG carrier, and an LNG carrier speed of 19 knots. Of course, gas-fired electrical generation plants rarely are operated at 100% capacity, and the typical load factor is closer to 50-60%, so the LNG required for a given electricity demand, is in reality reduced; therefore, the distance between the LNG hub and the receiving terminal may be increased by a corresponding proportion.

FIG. 4 is a flowchart of a method 400 for regasification of liquefied natural gas (LNG). At block 402 an LNG carrier is filled with LNG at an LNG hub. At block 404 the LNG carrier transports the LNG to an LNG receiving terminal. At block 406 the LNG is offloaded to LNG storage at the LNG receiving terminal. The LNG storage has less storage capacity than the storage capacity of the LNG carrier. At block 408 the LNG is regasified at a regasification rate using regasification equipment at the LNG receiving terminal. At block 410 the LNG carrier is maintained at the LNG receiving terminal until the LNG carrier is empty. As explained herein, the LNG carrier is considered empty even if an LNG heel remains therein. At block 412 the LNG carrier returns to the LNG hub when the LNG carrier is empty. Blocks 402 through 412 are repeated. The storage capacity of the LNG storage is sufficient to supply LNG to the regasification equipment to maintain regasifying the LNG at the regasification rate until the LNG carrier returns with additional LNG from the LNG hub. The LNG carrier is the sole source of LNG for the LNG receiving terminal.

The steps depicted in FIG. 4 are provided for illustrative purposes only and a particular step may not be required to perform the disclosed methodology. Moreover, FIG. 4 may not illustrate all the steps that may be performed. The claims, and only the claims, define the disclosed system and methodology.

The aspects described herein have several advantages over known technologies. For example, LNG markets too small to be cost-effectively served by the conventional LNG receiving terminals (onshore or floating) may now be efficiently served. The disclosed method also extends the life of older, less fuel-efficient LNG carriers that otherwise would be scrapped: because the less-efficient LNG carriers spend most of their time docked at receiving terminals, the efficiency difference between older carriers and newer, larger carriers is reduced or eliminated. Furthermore, a single LNG hub can service multiple LNG receiving terminals less expensively with the older, less expensive LNG carriers.

It should be understood that the numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

What is claimed is:

1. A method for regasification of liquefied natural gas (LNG), comprising:
(a) filling an LNG carrier with LNG at an LNG hub, the LNG carrier having a storage capacity;
(b) transporting the LNG in the LNG carrier to an LNG receiving terminal;
(c) offloading the LNG from the LNG carrier to LNG storage at the LNG receiving terminal, wherein the LNG storage has less storage capacity than the storage capacity of the LNG carrier;
(d) regasifying the LNG at a regasification rate using regasification equipment at the LNG receiving terminal;
(e) maintaining the LNG carrier at the LNG receiving terminal until the LNG carrier is empty;
(f) when the LNG carrier is empty, returning the LNG carrier to the LNG hub; and
(g) repeating steps (a)-(f);
wherein the storage capacity of the LNG storage is sufficient to supply LNG to the regasification equipment to maintain regasifying the LNG at the regasification rate until the LNG carrier returns with additional LNG from the LNG hub; and
wherein the LNG carrier is the sole source of LNG for the LNG receiving terminal.

2. The method of claim 1, wherein the LNG receiving terminal comprises a floating regasification unit.

3. The method of claim 1, wherein the LNG storage capacity of the LNG storage is between 5,000 and 50,000 cubic meters.

4. The method of claim 1, wherein the LNG storage capacity of the LNG storage is between 15,000 and 35,000 cubic meters.

5. The method of claim 1, wherein the LNG carrier has a maximum LNG storage capacity of between 100,000 and 150,000 cubic meters.

6. The method of claim 1, wherein the LNG receiving terminal is less than 3,500 kilometers away from the LNG hub.

7. The method of claim 1, wherein the regasification rate is less than one million tons of LNG per year (1 MTA).

8. The method of claim 1, wherein the LNG receiving terminal is one of a plurality of LNG receiving terminals, and wherein the LNG carrier is one of a plurality of LNG carriers, each of the plurality of LNG carriers being associated with a respective one of the plurality of LNG receiving terminals and dedicated as a sole source of LNG thereto, and wherein LNG storage at each of the plurality of LNG receiving terminals has a storage capacity that is smaller than a storage capacity of the respective LNC carrier associated therewith, the method further comprising:
filling each one of the plurality of LNG carriers with LNG at the LNG hub;
transporting LNG in each of the plurality of LNG carriers to the respective LNG receiving terminals;
offloading the LNG from said each of the plurality of LNG carriers to the LNG storage of the respective LNG receiving terminal;
regasifying the LNG using regasification equipment at the respective LNG receiving terminal; and
returning each of the plurality of LNG carriers to the LNG hub when said each LNG carrier is empty;
wherein the storage capacity of the LNG storage at each of the plurality of LNG receiving terminals is sufficient to supply LNG to the regasification equipment at said each LNG receiving terminal to maintain regasifying the LNG until the respective LNG carrier returns with additional LNG from the LNG hub.

9. An liquefied natural gas (LNG) regasification terminal, comprising:
an LNG carrier configured to be filled with LNG at an LNG hub, the LNG carrier having a storage capacity;
an LNG receiving terminal to which the LNG carrier is directed, the LNG carrier being the sole source of LNG for the LNG receiving terminal, the LNG receiving terminal comprising
LNG storage having a storage capacity, wherein the storage capacity of the LNG storage is less than the storage capacity of the LNG carrier, and wherein the LNG carrier is configured to offload the LNG to the LNG storage; and
regasification equipment configured to regasify the LNG stored in the LNG storage at a regasification rate;
wherein the LNG carrier is maintained at the LNG receiving terminal until the carrier is empty, and wherein the LNG carrier returns to the LNG hub when the LNG carrier is empty;
wherein the storage capacity of the LNG storage is sufficient to supply LNG to the regasification equipment to maintain regasifying the LNG at the regasification rate until the LNG carrier returns with additional LNG from the LNG hub.

10. The LNG regasification terminal of claim 9, wherein the LNG receiving terminal comprises a floating regasification unit.

11. The LNG regasification terminal of claim 9, wherein the LNG storage capacity of the LNG storage is between 5,000 and 50,000 cubic meters of LNG.

12. The LNG regasification terminal of claim 9, wherein the LNG storage capacity of the LNG storage is between 15,000 and 35,000 cubic meters of LNG.

13. The LNG regasification terminal of claim 9, wherein the LNG carrier has a maximum LNG storage capacity of between 100,000 and 150,000 cubic meters.

14. The LNG regasification terminal of claim 9, wherein the LNG receiving terminal is less than 3,500 kilometers away from the LNG hub.

15. The LNG regasification terminal of claim 9, wherein the regasification rate is less than one million tons of LNG per year (1 MTA).

16. The LNG regasification terminal of claim 9, wherein the LNG receiving terminal is one of a plurality of LNG receiving terminals, and wherein the LNG carrier is one of a plurality of LNG carriers, each of the plurality of LNG carriers being associated with a respective one of the plurality of LNG receiving terminals and dedicated as a sole source of LNG thereto, and wherein LNG storage at each of the plurality of LNG receiving terminals has a storage capacity that is smaller than a storage capacity of the respective LNC carrier associated therewith:
wherein each one of the plurality of LNG carriers is filled with LNG at the LNG hub;
wherein LNG is transported in each of the plurality of LNG carriers to the respective LNG receiving terminals and is
offloaded to the LNG storage of the respective LNG receiving terminal, and
regasified using the regasification equipment of the respective LNG receiving terminal; and
wherein each of the plurality of LNG carriers is returned to the LNG hub when said each LNG carrier is empty such that the storage capacity of the LNG storage of each of the plurality of LNG receiving terminals is sufficient to supply LNG to the regasification equipment at said each LNG receiving terminal, to maintain regasifying the LNG until the respective LNG carrier returns with additional LNG from the LNG hub.

17. A method for regasification of liquefied natural gas (LNG), comprising:
(a) filling an LNG carrier with LNG at an LNG hub, the LNG carrier having a maximum LNG storage capacity of between 100,000 and 150,000 cubic meters;
(b) transporting the LNG in the LNG carrier to a floating regasification unit, wherein the LNG carrier is the sole source of LNG for the floating regasification unit;
(c) offloading the LNG from the LNG carrier to LNG storage at the floating regasification unit, wherein the LNG storage has a maximum LNG storage capacity of between 15,000 and 35,000 cubic meters;
(d) regasifying the LNG at a regasification rate using regasification equipment at the floating regasification unit;
(e) maintaining the LNG carrier at the floating regasification unit until the LNG carrier is empty;
(f) when the LNG carrier is empty, returning the LNG carrier to the LNG hub; and
(g) repeating steps (a)-(f);
wherein the storage capacity of the LNG storage is sufficient to supply LNG to the regasification equipment to maintain regasifying the LNG at the regasification rate until the LNG carrier returns with additional LNG from the LNG hub.

18. The method of claim 17, wherein floating regasification unit is less than 3,500 kilometers away from the LNG hub.

19. The method of claim 17, wherein the regasification rate is less than one million tons of LNG per year (1 MTA).

20. A method for regasification of liquefied natural gas (LNG), comprising:
(a) filling an LNG carrier with LNG at an LNG hub, the LNG carrier having a storage capacity;
(b) transporting the LNG in the LNG carrier to one or more LNG receiving terminals;
(c) at each of the one or more receiving terminals,
(c1) offloading the LNG from the LNG carrier to LNG storage at the LNG receiving terminal, wherein the LNG storage at the LNG receiving terminal has less storage capacity than the storage capacity of the LNG carrier;
(c2) regasifying the LNG at a regasification rate corresponding to the LNG terminal;
(c3) maintaining the LNG carrier at the LNG receiving terminal until the LNG storage at the LNG terminal has sufficient LNG stored therein to maintain the regasification at the regasification rate until the LNG carrier returns to the LNG receiving terminal;
(d) when the LNG carrier is empty, returning the LNG carrier to the LNG hub; and
(e) repeating steps (a)-(d);
wherein the LNG carrier is the sole source of LNG for each of the LNG receiving terminals.
